(19) United States
(12) Patent Application Publication
(10) Pub. No.: US 2022/0061337 A1
(43) Pub. Date: Mar. 3, 2022

(54) DEVICE FOR MAKING FILLED DOUGH PRODUCTS

(71) Applicant: FRITSCH BAKERY TECHNOLOGIES GMBH & CO. KG, Markt Einersheim (DE)

(72) Inventors: Udo BERNHARDT, Iphofen (DE); Alfred STROEBEL, Ochsenfurt (DE)

(73) Assignee: FRITSCH BAKERY TECHNOLOGIES GMBH & CO. KG, Markt Einersheim (DE)

(21) Appl. No.: 17/405,546

(22) Filed: Aug. 18, 2021

(30) Foreign Application Priority Data
Aug. 25, 2020 (DE) 102020210735.1

(51) Int. Cl. A21C 9/06; A21C 9/08

(52) U.S. Cl. CPC A21C 9/063; A21C 9/088

(57) ABSTRACT

A device for making filled dough products comprises a conveyor device configured to convey dough pieces in a production direction, a holding belt disposed above the conveyor device and configured to engage a filling, which is disposed on one of the dough pieces, and a winding device configured to fold and/or wind one of the dough pieces. The winding device comprises a folding device adapted to fold a folding portion of the dough piece upwards, wherein the folding device comprises a hook, which is pivotably disposed above the conveyor device.

### CROSS-REFERENCE TO RELATED APPLICATIONS

This application claims foreign priority benefits under 35 U.S.C. § 119(a)-(d) to German patent application number DE 10 2020 210 735.1, filed Aug. 25, 2020, which is incorporated by reference in its entirety.

### TECHNICAL FIELD

The disclosure relates to devices for making filled dough products.

### BACKGROUND

Such devices are, for example, known from EP 1 726 209 A2 by the applicant. The winding system disclosed therein is adapted to roll certain fillings into a dough piece. In this process, a conveying belt initially delivers a dough piece, on which a filling is placed. The filling is pressed into the dough piece by a pressing arrangement disposed above the conveying belt, whereby an adhesion between the dough piece and the filling is to be generated. The filling is wound into the dough piece by a winding conveying unit, which is also disposed above the conveying belt but downstream of the pressing arrangement. For this purpose, the winding conveying unit engages the filling such that the latter is caused to rotate. By the previously generated adhesion, the portion of the dough piece adhering to the filling is lifted off the conveying belt and consequently the winding motion is initiated.

In practice, it turned out that a reliable generation of the adhesion between the dough piece and filling sometimes cannot be achieved at all and sometimes can only be achieved by additional measures, such as wetting the dough piece with a liquid. Further, the winding system disclosed in EP 1 726 209 A2 only enables substantially round fillings having a substantially stable shape to be wound into dough pieces, but not for example pasty or flat fillings, such as cheese or ham slices.

In order to generate dough products filled with pasty fillings, EP 2 366 290 A1 proposes to use pivoting arms as winding components. However, these pivoting arms according to this disclosure, have to be disposed very close to the bearing surface of the conveying belt or resting on this surface, in order to fulfill their winding function. This poses the risk that pasty fillings are smeared by the pivoting arms. In an effort to reduce this risk, EP 2 366 290 A1 proposes to space the winding components apart from each other transverse to the production direction. With stable shape fillings, in particular ones having a larger vertical thickness than the dough piece and or extending laterally beyond the dough piece, this configuration may cause problems because the winding components contact the filling before they contact the dough piece. This may cause the filling to be moved on the dough piece or even be pushed off the dough piece entirely.

Improvements relating to dough molding machinery for producing unfilled dough products are known from GB 183848 A. Therein, a combination of a pressing roller and a hook is used to turn an unfilled dough piece upwards at its front edge. However, in the manufacturing of filled dough pieces, this may also cause fillings, in particular substantially stable shape fillings, to be undesirably shifted by turning the dough piece upwards. In particular with round, e.g., rollable fillings, this may lead to substantial disruptions of the production process through fillings rolling off.

### SUMMARY

Therefore, it is an object of the present disclosure to provide a device for making filled dough products, which enables an operation with less disruptions and, therefore, more efficient operation.

The disclosure provides a device for making filled dough products. The device comprises a conveyor device, which is configured to convey dough pieces in a production direction, at least one holding belt (or 2, 3, several), which is disposed above the conveyor device and is configured to engage a filling, which is disposed on one of the dough pieces, and a winding device, which is configured to fold and/or wind one of the dough pieces and comprises a folding device, which is adapted to fold a folding portion of the dough piece upwards, wherein the folding device comprises at least one (or 2, 3, several) hook, which is pivotably disposed above the conveyor device.

In contrast to pressing to cause adherence between filling and dough piece alone, the hooks for folding the dough piece upwards may increase the reliability of the winding process. In particular a separation of the dough piece from the filling may be inhibited. In particular with stable shape and or rollable fillings, a shifting of the filling by the folding device may be prevented by the combination of the hooks with the holding belt, which may further increase reliability.

The distance of the holding belt from the conveyor device may be adjustable. Thereby, the device may be adapted to different products to be made, in particular fillings of different sizes. In addition to the folding device, the winding device may comprise a winding element. The latter may be configured to continue the winding process initiated by the folding device, preferably until the entire dough piece is wound up. The winding element may be disposed above the conveyor device. It may be embodied as a winding mat, for example made of a wire mesh belt, or as a conveyor belt. A distance between the winding element and the conveyor device may be adjustable. Thereby, for example an encompassing angle of the winding element around the dough product may be adjustable.

The hook may have an engagement portion, which is configured to engage a dough piece conveyed on the conveyor device. This may mean that in a resting position and or starting position of the hook, the engagement portion may rest on the conveyor device or the distance of the engagement portion to a surface of the conveyor device may be smaller than a thickness of the dough piece. The thickness of the dough piece may be defined in a direction that is oriented orthogonal to the surface of the conveyor device.

Preferably, the hook may be pivotable from a starting position towards a displaced position by the engagement of the engagement portion with the dough piece and the conveying of the dough piece by the conveyor device. This may have the advantage that no additional and or separate drive needs to be provided for moving the hook.

It may be advantageous, if the engagement portion is disposed downstream of a downstream end portion of the holding belt in the displaced position of the hook. This may enable the hook still engaging the dough piece in the displaced position. This in turn may enable that the dough piece is folded around the filling as far as possible, preferably by 90°, particularly preferred by 180°. It may further be enabled that the folded dough piece may be transferred directly to the following component of the winding device, but in particular the winding element. A portion of the holding belt at which the filling is disengaged from the holding belt, may be considered a downstream end portion of the holding belt.

It is particularly beneficial, if a pivoting axis, about which the hook is pivotable, is oriented transverse, preferably orthogonal, to the production direction. In this way the driving effect of the conveyor device described above may be taken advantage of in a particularly effective way.

Advantageously, the pivoting axis may be disposed upstream of a downstream end portion of the holding belt. This may enable that the engagement portion of the hook mentioned above may be disposed downstream of and as close as possible to the downstream end portion of the holding belt. This in turn may enable a direct transfer of the folded dough piece from the hook to the following component of the winding device, particularly the winding element.

The folding device may in particular comprise two hooks. A higher number of hooks is also conceivable. Embodiments having two or more hooks may be beneficial because very wide dough pieces may be folded upwards reliably and uniformly as well. In embodiments having two or more hooks, it is advantageous, if the hooks are pivotable about a common pivoting axis. This may be a common physical axis, for example in the form of a shaft. Alternatively, each individual hook or individual groups of hooks may be supported at an individual physical axis, wherein all physical axes are oriented in parallel, preferably collinear, with respect to each other.

It is particularly beneficial if the holding belt is disposed between the two hooks. This may reduce the risk of an asymmetric winding. In particular in embodiments having more than two hooks, it is conceivable that one, two or more holding belts alternate with the hooks, preferably in a direction along a common pivoting axis of the hooks.

It is conceivable that the winding device comprises a winding mat, which is disposed above the conveyor device, and which is configured to engage the dough piece from above, in particular to rest on the dough piece. A winding mat may represent a particularly simple and cost efficient possibility to finish winding the dough products after the initial folding.

It may be advantageous, if the device comprises a suction device, which is configured to generate an underpressure below the conveyor device, wherein the conveyor device has openings allowing the dough pieces to be sucked to the conveyor device by the underpressure. This may improve the grip of the dough piece on the conveyor device. An improved grip may facilitate the conveying of the dough piece by the conveyor device. This may decrease the risk that a potential decelerating effect of the hook during engagement with the dough piece causes the conveyor device to slip underneath the dough piece.

It is particularly advantageous, if the suction device is configured to generate the underpressure along a suction track, which extends along the production direction wherein an end of the suction track is disposed upstream of a location, at which the winding device initially engages the dough piece. Alternatively or additionally, the location, at which the winding device initially engages the dough piece may be defined as the location, at which the engagement portion of the hook is closest to the conveyor device in the starting position of the hook. Both definitions may be used synonymously.

By disposing the end of the suction track and the above defined location relative to one another, a lifting of a front edge of the dough piece by the hook may be facilitated because the front edge of the dough piece is no longer sucked when it engages the hook, in particular the engagement portion. It is particularly beneficial, if the end of the suction track is disposed at a distance from the location, at which the winding device initially engages the dough piece.

### BRIEF DESCRIPTION OF THE DRAWINGS

The disclosure relates to a device for making filled dough products as described above. In the following, a preferred embodiment is explained in more detail using drawings.

FIG. 1 shows a schematic sectional side view of a device for making filled dough products;

FIG. 2 shows a detailed view of a portion of FIG. 1, wherein the dough piece engages a hook of the device;

FIG. 3 shows a view similar to FIG. 2, wherein the upwardly folded dough piece is transferred to a winding element;

FIG. 4 shows a similar view to FIGS. 2 and 3, wherein the dough product has been wound further by the winding element; and

FIG. 5 shows a perspective view of the device for making filled dough products.

### DETAILED DESCRIPTION

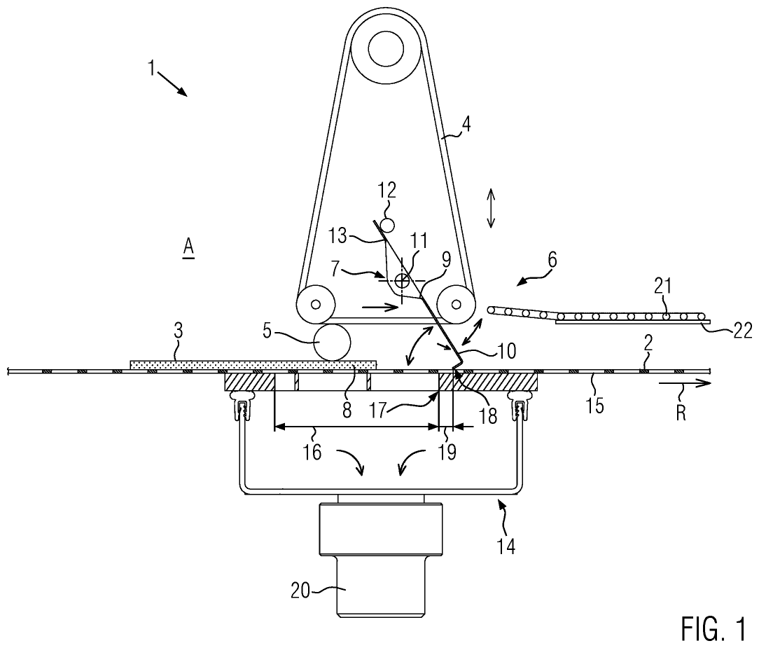

FIG. 1 shows a device 1 for making filled dough products in a schematic sectional side view. The device 1 may comprise a conveyor device 2. The conveyor device 2 may be configured to convey dough pieces 3 in a production direction R. As shown in the present embodiment, the conveyor device 2 may comprise a conveyor belt. The device 1 may further comprise a holding belt 4. The holding belt 4 may be disposed above the conveyor device 2. The holding belt 4 may be configured to engage a filling 5, which each may be disposed on one of the dough pieces 3. The device may further comprise a winding device 6. The winding device 6 may be configured to fold and/or wind one of the dough pieces 3. The winding device 6 may comprise a folding device 7.

The folding device 7 may be adapted to fold a folding portion 8 of the dough piece 3 upwards. For this purpose, the folding device 7 may comprise a hook 9. The hook 9 may be pivotably disposed above the conveyor device 2. The hook 9 may have an engagement portion 10. The engagement portion 10 may be configured to engage a dough piece 3 being conveyed on the conveyor device 2. As shown in the present embodiment, this may be achieved by a suitable positioning, in particular a spacing, of a pivoting axis 11, about which the hook 9 may be pivotable, relative to the conveyor device 2. Further, a stop 12 may be provided. The stop 12 may be configured to engage a stop portion 13 provided at the hook 9. The stop portion 13 may be disposed at a side of the hook 9, which is disposed opposite the engagement portion 10 with respect to the pivoting axis 11. Alternatively or additionally to the suitable spacing of the pivoting axis 11 from the conveyor device 2, a desired engagement of the engagement portion 10 with the dough piece 3 may be achieved by a suitable positioning of the stop 12.

The device 1 may further comprise a suction device 14. The suction device 14 may be configured to generate underpressure below the conveyor device 2. Furthermore, the conveyor device 2 may have openings 15. This may enable the dough pieces 3 to be suckable to the conveyor device 2 by the underpressure. By sucking of the dough pieces 3 to the conveyor device 2, a grip between the dough pieces 3 and the conveyor device 2 may be increased. The suction device 14 may be configured to generate the underpressure along a suction track 16.

The suction track 16 may extend along the production direction R. An end 17 of the suction track 16 may be disposed upstream of a location 18, at which the winding device 6, in particular the folding device 7, initially engages the dough piece 3. In particular, the end 17 of the suction track 16 may be disposed at a distance 19 from the location 18. This may facilitate the folding upwards of the folding portion 8 of the dough piece 3. In order to generate the underpressure, the suction device 14 may have an underpressure generator 20, such as a pump, a vacuum pump or a compressor.

The winding device 6 may further have a winding element 21. The winding element 21 may be disposed downstream of the folding device 7. The winding element 21 may be configured to continue the winding process initiated by the folding device 7. The winding elements 21 may be disposed above the conveyor device 2. As shown in the present embodiment, the winding element 21 may be or comprise a winding mat. In particular, winding mats made of a wire mesh belt are conceivable. Alternatively, the winding elements 21 may be or comprise a conveyor belt.

The distance between the winding element 21 and the conveyor device 2 may be adjustable. In cases, such as the present embodiment, in which the winding element comprises a winding mat, one or more holders 22 may be provided. The winding element 21, in particular the winding mat, may for example rest on the holders 22.

In the following, the functioning of the device 1 is explained in more detail in view of the embodiment shown in the figures. FIG. 1 shows the dough piece 3 and the filling 5 disposed on it before the dough piece 3 engages the engagement portion 10 of the hook 9. It can be seen that the holding band 4 may be adapted to engage the filling 5. A configuration, in which it is achieved that the filling 5 is held at the position relative to the dough piece 3, is particularly preferred. For this purpose, the holding band 4 may be driven at the same speed as the conveyor device 2. However, it is also conceivable that the positioning of the filling 5 on the dough piece 3 may be selectively influenced and or changed, for example by different driving speeds of the holding belt 4 and the conveyor device 2.

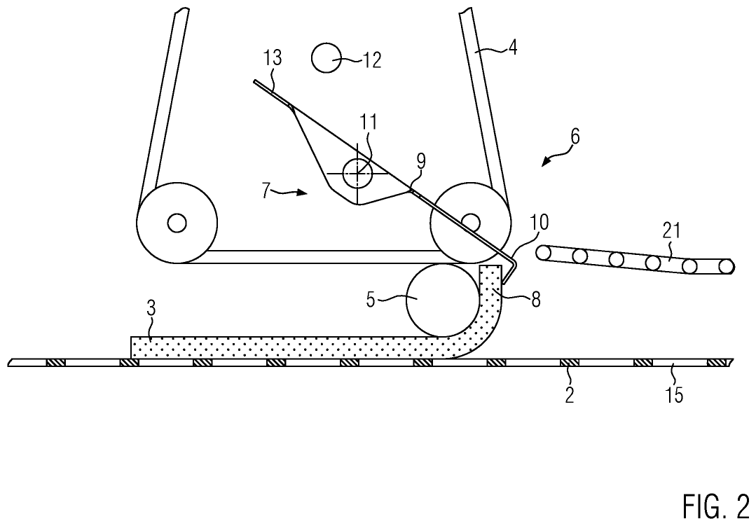

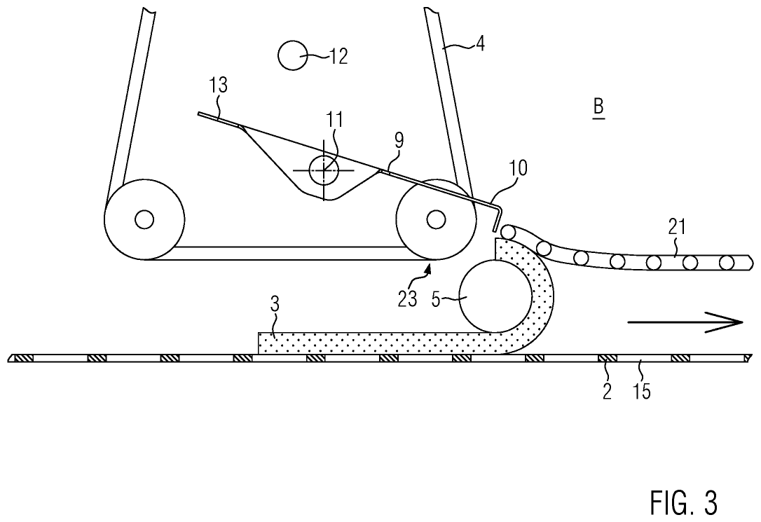

In FIG. 1, the hook is disposed in a starting position A. By the engagement of the dough piece 3, in particular the folding portion 8, with the hook 9, in particular with the engagement portion 10, and the conveying of the dough piece 3 by the conveyor device 2, the hook 9 may be moved from a starting position A in a direction towards a displaced position B (see FIG. 3). FIG. 2 shows the hook 9 during the movement from the starting position A towards the displaced position B.

In FIG. 3, the hook 9 is shown in the displaced position B. In this position, the engagement portion 10 of the hook 9 may disengage the dough piece 3. Furthermore, in this position, the engagement portion 10 of the hook 9 may be disposed downstream of a downstream end portion 23 of the holding belt 4. At said downstream end portion 23 of the holding belt 4, the holding belt 4 may disengage the filling 5. In FIG. 3, it may also be seen that the winding element 21 engages the dough piece 3 immediately after the engagement portion 10 disengages the dough piece 3.

The pivoting axis 11 may be disposed upstream of the downstream end portion 23 of the holding belt 4. The pivoting axis 11 may be oriented transverse to the production direction R, preferably, as in the present embodiment, orthogonal to the production direction R.

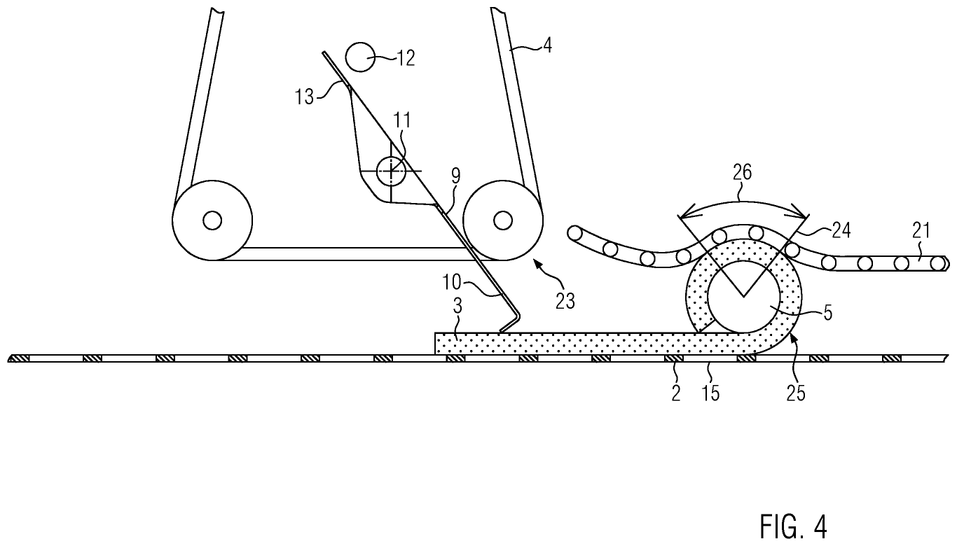

As may be seen in FIG. 4, the dough piece 3 may be wound around the filling 5 by a difference in speed between the conveyor device 2 and the winding element 21. It may also be seen that the hook 9 may be moved towards its starting position A by gravity. It may also be seen, that the winding element 21 rests on the dough product 25 in an encompassing sector 24. The encompassing sector 24 may have an encompassing angle 26. A skilled person will recognize that the encompassing angle 26 may be adjustable by a distance between the winding element 21 and the conveyor device 2.

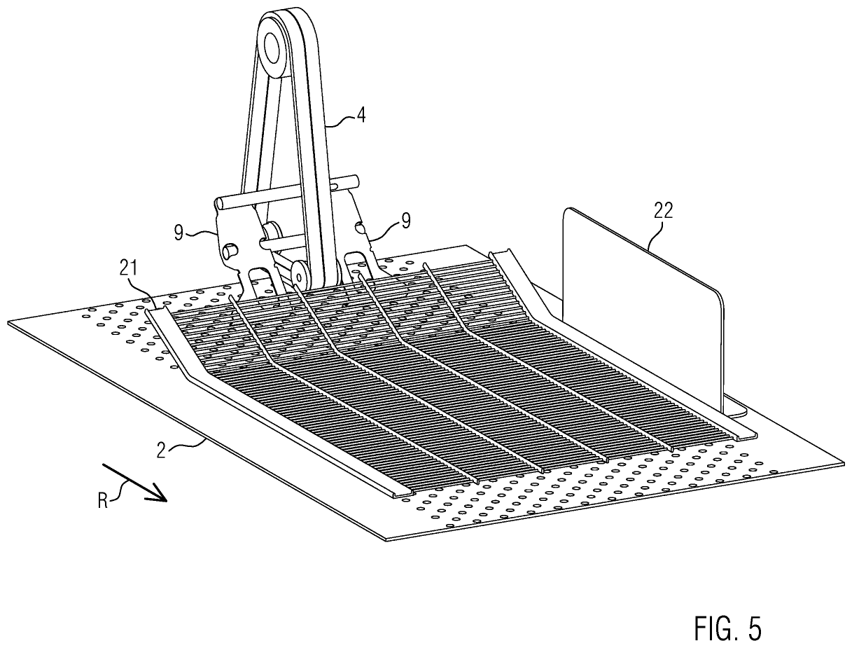

FIG. 5 illustrates that the winding device 6, in particular the folding device 7, may have two hooks 9. The two hooks 9 may be spaced transverse to the production direction R, in particular orthogonal to the production direction R. The holding belt 4 may be disposed between the hooks 9. Further, the holder 22, which may be disposed in a lateral edge area of the conveyor device may be seen better. In particular, two holders 22 may be provided, of which only one is shown in FIG. 5 for better visibility of the other components. A second holder 22 may, for example, be disposed at an opposite side of the winding element 21.

What is claimed is:

1. A device for making filled dough products, comprising:
a conveyor device configured to convey dough pieces in a production direction;
at least one holding belt disposed above the conveyor device and configured to engage a filling disposed on one of the dough pieces; and
a winding device configured to fold and/or wind the one dough piece and comprising a folding device, which is adapted to fold a folding portion of the one dough piece upwards, wherein the folding device comprises a hook pivotably disposed above the conveyor device.

2. The device according to claim 1, wherein the hook has an engagement portion configured to engage the one dough piece as the one dough piece is conveyed on the conveyor device.

3. The device according to claim 2, wherein the hook is pivotable from a starting position towards a displaced position by the engagement of the engagement portion with the one dough piece and the conveying of the one dough piece by the conveyor device.

4. The device according to claim 3, wherein the engagement portion is disposed downstream of a downstream end portion of a holding belt of the at least one holding belt in the displaced position of the hook.

5. The device according to claim 1, wherein a pivoting axis, about which the hook is pivotable, is oriented transverse to the production direction.

6. The device according to claim 5, wherein the pivoting axis is oriented orthogonal to the production direction.

7. The device according to claim 5, wherein the pivoting axis is disposed upstream of a downstream end portion of a holding belt of the at least one holding belt.

8. The device according to claim 1, wherein the folding device comprises an additional hook.

9. The device according to claim 8, wherein a holding belt of the at least one holding belt is disposed between the two hooks.

10. The device according to claim 1, wherein the winding device comprises a winding mat, which is disposed above the conveyor device, and which is configured to engage the one dough piece from above.

11. The device according to claim 10, wherein the winding mat is configured to rest on the one dough piece.

12. The device according to claim 1 further comprising a suction device configured to generate an underpressure below the conveyor device, wherein the conveyor device has openings to allow the dough pieces to be sucked to the conveyor device by the underpressure.

13. The device according to claim 12, wherein the suction device is configured to generate the underpressure along a suction track, which extends along the production direction, wherein an end of the suction track is disposed upstream of a location at which the winding device is initially engageable with the one dough piece.

14. The device according to claim 13, wherein the end of the suction track is disposed at a distance from the location at which the winding device is initially engageable with the one dough piece.
